(19) United States
(12) Patent Application Publication
(10) Pub. No.: US 2025/0220587 A1
(43) Pub. Date: Jul. 3, 2025

(54) ON/OFF INDICATION FOR RRC-IDLE/RRC-INACTIVE NCR-MT

(71) Applicant: MEDIATEK INC., Hsinchu City (TW)

(72) Inventors: Chun-Hao FANG, Hsinchu City (TW); Cheng-Rung TSAI, Hsinchu City (TW); Lung-Sheng TSAI, Hsinchu City (TW)

(21) Appl. No.: 18/851,937

(22) PCT Filed: Sep. 28, 2023
(86) PCT No.: PCT/CN2023/122605

§ 371 Date: Sep. 27, 2024

Related U.S. Application Data
(60) Provisional application No. 63/377,554, filed on Sep. 29, 2022.

(51) Int. Cl. H04W 52/02; H04W 68/00; H04W 72/232; H04W 76/27

(52) U.S. Cl. CPC H04W 52/0274; H04W 68/00; H04W 72/232; H04W 76/27

(57) ABSTRACT

In an aspect of the disclosure, a method, a computer-readable medium, and an apparatus are provided. The apparatus may be a wireless device. The wireless device receives, by a mobile termination (MT) component of the wireless device while in a radio resource control (RRC) idle or inactive state, a control message via one of a paging early indication (PEI), paging downlink control information (DCI), or a paging message. The wireless device determines an activation or deactivation operation for a forwarding component of the NCR according to the control message. The wireless device performs the activation or deactivation operation at the forwarding component.

### CROSS-REFERENCE TO RELATED APPLICATION(S)

This application claims the benefits of U.S. Provisional Application Ser. No. 63/377,554, entitled “ON/OFF INDICATION FOR RRC-IDLE/RRC-INACTIVE NCR-MT” and filed on Sep. 29, 2022, which is expressly incorporated by reference herein in its entirety.

### TECHNICAL FIELD

The present disclosure relates generally to communication systems, and more particularly, to techniques of transmitting ON/OFF indications to a network-controlled repeater (NCR).

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device. The wireless device receives, by a mobile termination (MT) component of the wireless device while in a radio resource control (RRC) idle or inactive state, a control message via one of a paging early indication (PEI), paging downlink control information (DCI), or a paging message. The wireless device determines an activation or deactivation operation for a forwarding component of the NCR according to the control message. The wireless device performs the activation or deactivation operation at the forwarding component.

In an aspect of the disclosure, a method, a computer-readable medium, and an apparatus are provided. The apparatus may be a base station. The base station determines an activation or deactivation operation of a forwarding component of a wireless device while a mobile termination (MT) component of the wireless device is in a radio resource control (RRC) idle or inactive state. The base station transmits, to the MT component, a control message via one of a paging early indication (PEI), paging downlink control information (DCI), or a paging message. The control message indicates the activation or deactivation operation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating communications among a base station, a network-controlled repeater (NCR), and user equipment (UE).

FIG. 8 a diagram illustrating a first scheme of a control message.

FIG. 9 is a diagram illustrating a second scheme of a control message.

FIG. 10 is a diagram illustrating a third scheme of a control message.

FIG. 11 is a diagram illustrating a first frequency domain resource configuration included in a control message.

FIG. 12 is a diagram illustrating a second frequency domain configuration included in a control message.

FIG. 13 is a flow chart of a method (process) for performing activation or deactivation operations.

FIG. 14 is a flow chart of a method (process) for sending activation or deactivation indications.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

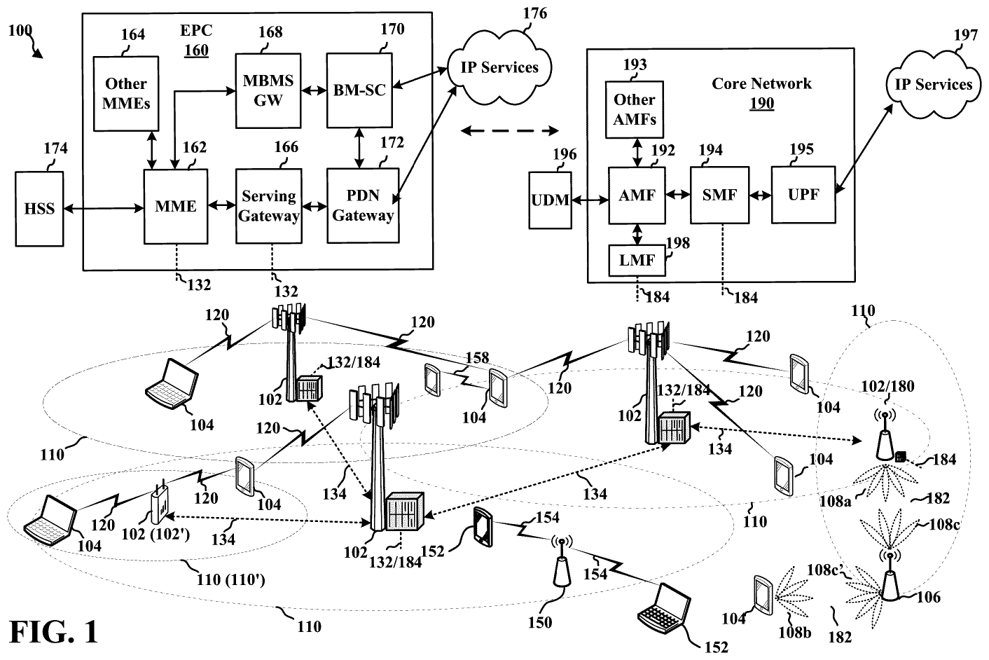

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to X MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

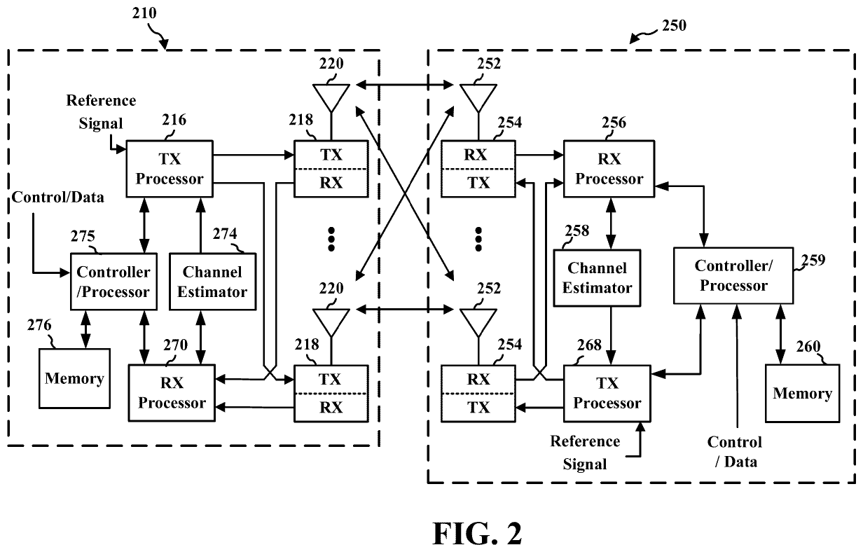

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

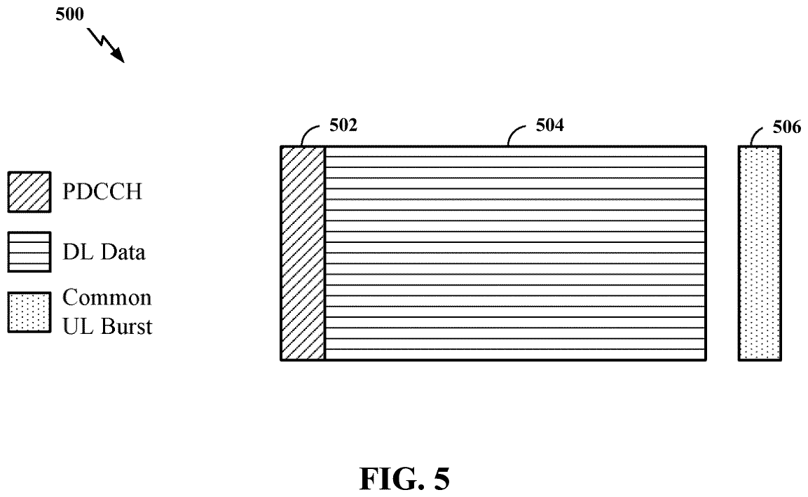

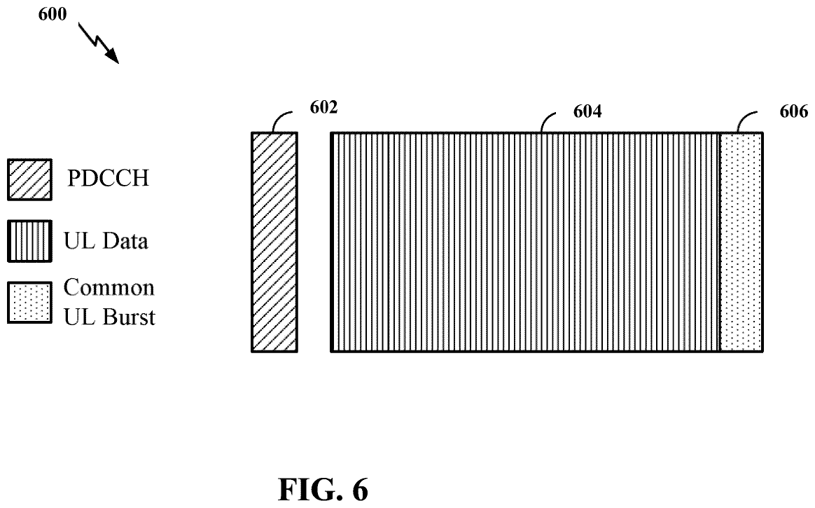

A single component carrier bandwidth of 100 MHz may be supported. In one example, NR resource blocks (RBs) may span 12 sub-carriers for each RB with a sub-carrier spacing (SCS) of 60 kHz over a 0.25 ms duration or a SCS of 30 kHz over a 0.5 ms duration (similarly, 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

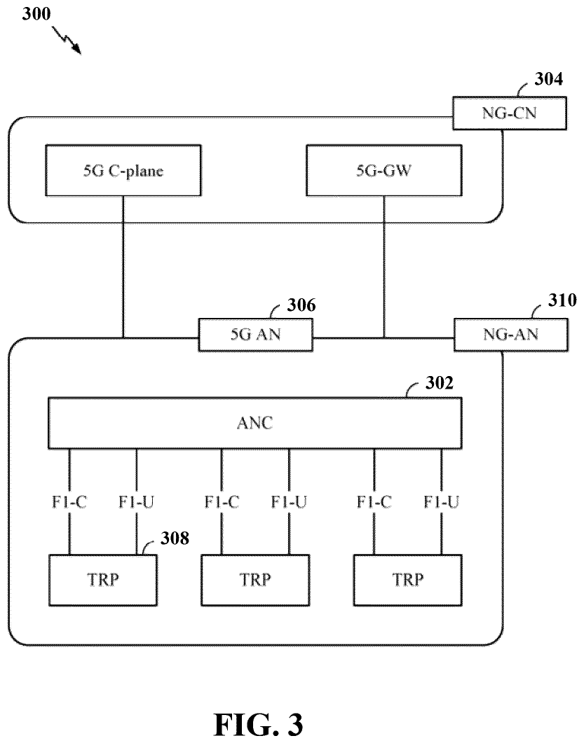

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC.

The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

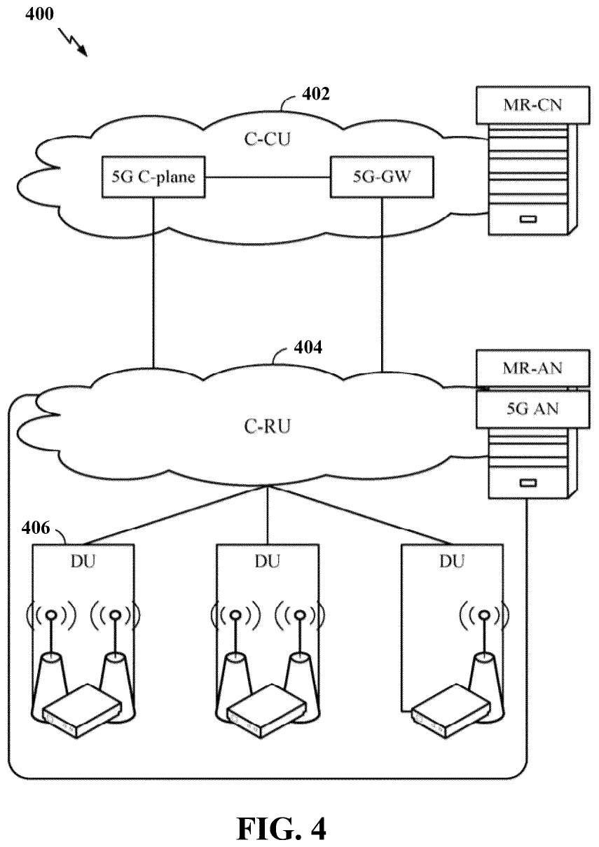

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UEL) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

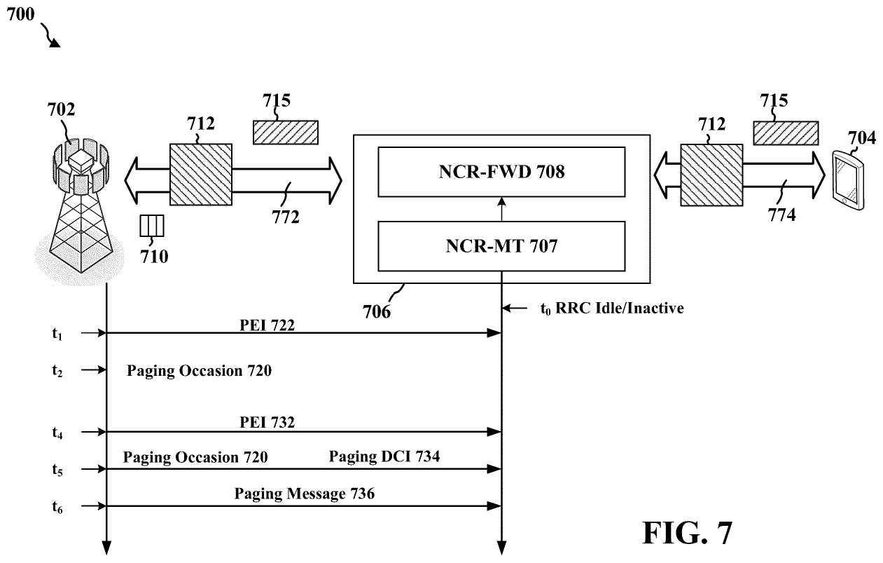

FIG. 7 is a diagram 700 illustrating communications among a base station, a network-controlled repeater (NCR), and a UE. An NCR receives RF signals, and then amplifies and forwards the received RF signals. An NCR includes of a control component NCR-mobile termination (NCR-MT) which communicates with the base station via a control link, and an amplify-and-forwarding component NCR-forwarding (NCR-FWD) which performs the amplify-and-forward action between the base station and UE via a backhaul link and access link. The behavior of the NCR-FWD may be controlled by the NCR-MT according to the control information received from the base station.

Specifically, the NCR-FWD can receive downlink (DL) RF signals from the base station via the backhaul link and forward the DL signals to the UE via the access link. Similarly, the NCR-FWD can receive uplink (UL) RF signals from the UE via the access link and forward the UL signals to the base station via the backhaul link. The NCR-FWD is able to receive and forward the DL/UL RF signals in a frequency range [fₛₜₐᵣₜ, f_{end}].

In this example, a base station 702 communicates with a UE 704 through an NCR 706 and using a backhual link 772 and an access link 774. The NCR 706 includes an NCR-MT 707 and an NCR-FWD 708. The NCR-FWD 708 is able to receive and forward the DL/UL RF signals in a frequency range [fₛₜₐᵣₜ, f_{end}]. The base station 702 may transmit a PDCCH 710 to the NCR-MT 707. In certain scenarios, the PDCCH 710 may schedule transmission of a PDSCH 712. In certain scenarios, the PDCCH 710 may schedule a PUSCH 715.

When there is no active signal forwarding required, the NCR-MT 707 may enter the RRC_IDLE or RRC_INACTIVE state to reduce power consumption. The NCR-MT 707 may wake up at paging occasions to detect paging DCI that schedule a paging message. In certain configurations, the base station 702 may use paging early indication (PEI) mechanism to indicate to the NCR-MT 707 whether the NCR-MT 707 needs to wake up at a paging occasion to detect paging DCI. Specifically, the base station 702 may transmit a PEI to the NCR-MT 707 in advance of its paging occasion (PO) to notify the NCR-MT 707 to skip this PO or to monitor this PO. The PEI can be signaled via a DCI message carried in the PDCCH prior to the PO. Within a PO, the base station 702 initiates the paging procedure by transmitting a DCI message. This DCI message includes information about the paging message, such as the time-frequency resources on which the paging message will be transmitted. Following the DCI message, the base station 702 transmits the actual paging message on the specified resources. The paging message contains information about the incoming event, including the NCR-MT 707's identity (such as its temporary mobile subscriber identity—TMSI) and other relevant details.

In this example, the NCR-MT 707 may enter the RRC_IDLE/RRC_INACTIVE state at time to. Optionally, the base station 702 transmits a PEI 722 to the NCR-MT 707 at time t₁ prior to a PO 720 that occurs at t₂. The PEI 722 notifies the NCR-MT 707 to skip the PO 720. Accordingly, the NCR-MT 707 stays in RRC_IDLE/RRC_INACTIVE state at the PO 720. When the base station does not transmit the PEI 722, the NCR-MT 707 wakes up at t₂ to detect paging DCI.

Subsequently, the base station 702 transmits a PEI 732 to the NCR-MT 707 at time t₄ prior to a PO 730 that occurs at time t₅. The PEI 732 notifies the NCR-MT 707 to monitor the PO 730. Accordingly, the NCR-MT 707 wakes up at t₅. When the base station does not transmit the PEI 722, the NCR-MT 707 also wakes up at t₅ to detect paging DCI. The base station transmits, at the PO at t₅, DCI 734 that schedules a paging message 736 to be transmitted at t₆. At t₆, the base station transmits the paging message to the NCR-MT 707.

The base station 702 may also send a control message to the NCR-MT 707 to turn on and off functions of the NCR-FWD 708 according to whether there is a need for such functions. In a first configuration, the PEI is modified to include the control message, which indicates time-frequency resources for NCR-FWD 708 activation/deactivation. This can be done by: reinterpreting the paging indication field or TRS availability indication field of PEI 732; introducing bits/field in DCI format 2_7 dedicated to conveying on/off status or on duration for NCR-FWD 708; or creating a DCI format to carry PEI 732 with necessary fields for NCR-FWD 708 time-frequency resource indication.

In a second configuration, the paging DCI is modified to include the control message, which indicates time-frequency resources for NCR-FWD 708 activation. This can be done by: reinterpreting the short messages indicator or short messages of DCI 734; introducing bits/field in DCI format 1_0 dedicated to conveying NCR-FWD 708 activation information; or creating a DCI format to carry control info for paging message with required NCR-FWD 708 fields.

In a third configuration, field/bits in paging message 736 itself are used to carry the control message, which indicates time-frequency resources for NCR-FWD 708 activation.

Further, the time/frequency domain resource information indicated by the on/off indications includes at least one of: starting position for NCR-FWD to transition between on/off states after receiving indication; and on duration that NCR-FWD remains in on state; For frequency domain, the on/off indication can either turn on/off the entire NCR-FWD frequency range [fₛₜₐᵣₜ, f_{end}], or specify particular frequency sub-ranges to turn on/off.

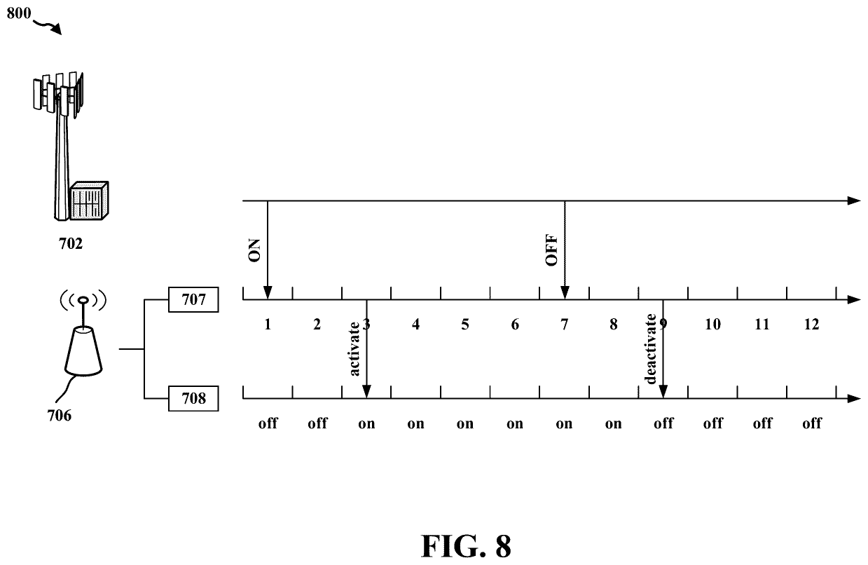

FIG. 8 a diagram 800 illustrating a first scheme of a control message. The base station 702 transmits control signals to the NCR-MT 707 in a PEI (e.g., the PEI 722, the PEI 732), paging DCI (e.g., the paging DCI 734), or paging message (e.g., the paging message 736). The NCR-MT 707 decodes the received control signals and controls the NCR-FWD 708 according to the control signals.

To ensure that the NCR-MT 707 has sufficient time to accurately decode the control signals, a delay time interval from when the NCR-MT 707 receives the indication from the base station 702 to when the NCR-MT 707 changes the NCR-FWD 708's state can be also configured by the base station 702.

In this example, the delay time interval is 2 time units, where a time unit can be a slot, symbol, millisecond, microsecond or second. At the first time unit, the base station 702 transmits an ON indication to the NCR-MT 707 to instruct the NCR-MT 707 to activate the NCR-FWD 708. After 2 time units, at the third time unit, the NCR-MT 707 activates the NCR-FWD 708 according to the received ON indication, transitioning the NCR-FWD 708 from the OFF state to the ON state. The NCR-FWD 708 will remain in the ON state until the NCR-MT 707 deactivates the NCR-FWD 708 according to a received OFF indication from the base station 702.

The base station 702 transmits an OFF indication at the seventh time unit to the NCR-MT 707 to instruct the NCR-MT 707 to deactivate the NCR-FWD 708. After 2 time units, at the ninth time unit, the NCR-MT 707 deactivates the NCR-FWD 708 according to the received OFF indication, transitioning the NCR-FWD 708 from the ON state to the OFF state.

The ON indication transmitted by the base station 702 contains information indicating when and on which frequency resources the NCR-FWD 708 should activate. The OFF indication contains information indicating when the NCR-FWD 708 should deactivate.

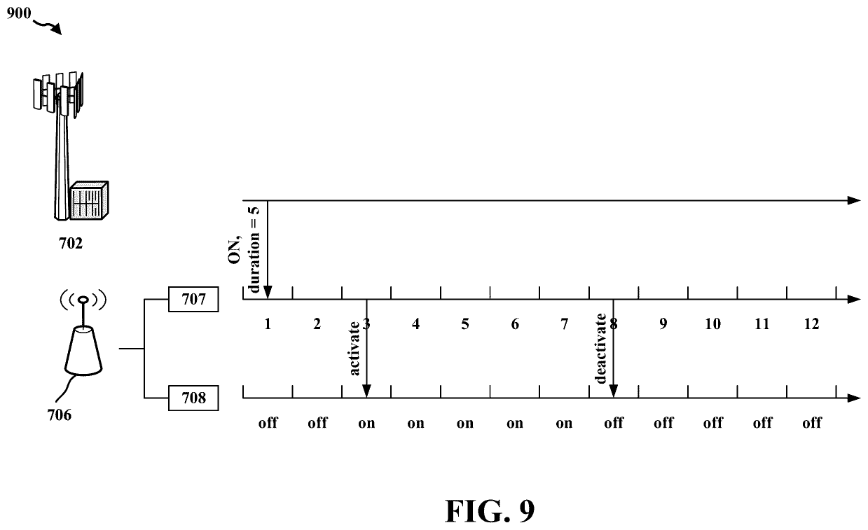

FIG. 9 is a diagram 900 illustrating a second scheme of a control message. In this example, at the first time unit, the base station 702 transmits, to the NCR-MT 707, a control message including an ON indication and an ON duration of 5 time units to the NCR-MT 707. Accordingly, after the configured delay timal interval, which is 2 time units in this example, at the third time unit, the NCR-MT 707 activates the NCR-FWD 708 according to the received ON indication, transitioning the NCR-FWD 708 from the OFF state to the ON state.

The ON duration indicates that the NCR-FWD 708 should remain in the ON state for 5 time units. Therefore, after 5 time units, at the eighth time unit, the NCR-MT 707 deactivates the NCR-FWD 708, transitioning the NCR-FWD 708 from the ON state to the OFF state.

As shown, in this scheme, the base station transmits an ON indication and ON duration to the NCR-MT. The NCR-MT activates the NCR-FWD after a delay for processing the indication. The NCR-FWD remains ON for the indicated ON duration. After the ON duration expires, the NCR-MT deactivates the NCR-FWD. In other words, the NCR-MT automatically deactivates the NCR-FWD after the specified duration without needing an explicit OFF indication.

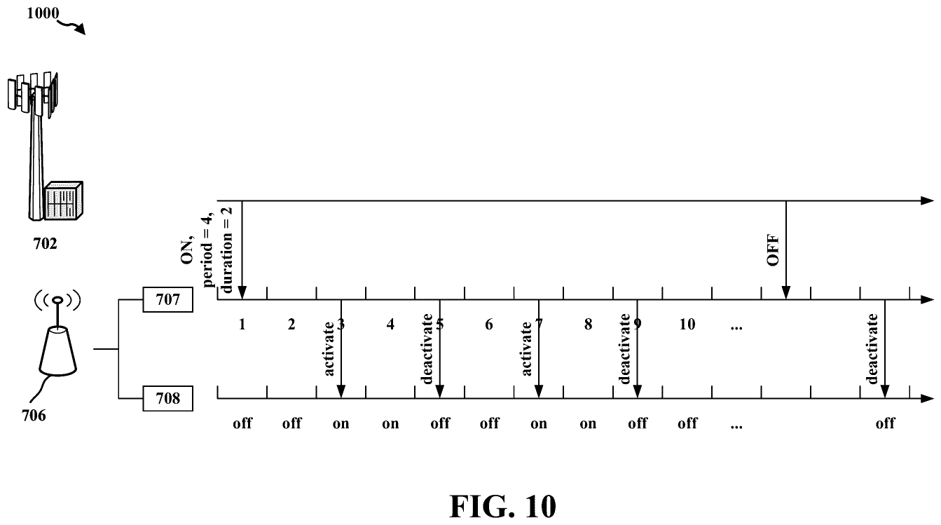

FIG. 10 is a diagram 1000 illustrating a third scheme of a control message. In this example, the base station 702 transmits in the first time unit a control message including an ON indication, an ON-period for x time units and an ON-duration within the period for y (y≤x) time units to the NCR-MT 707. In this example, x=4 time units and y=2 time units. After the configured delay time interval, which is 2 time units in this example, at the third time unit, the NCR-MT 707 activates the NCR-FWD 708 according to the received ON indication and the NCR-FWD 708 transitions from the off state to the on state. The NCR-FWD 708 will remain in the on state for y time units. After y time units, the NCR-MT 707 deactivates the NCR-FWD 708 according to the received ON-duration for y (e.g., 2) time units and the NCR-FWD 708 transitions from the on state to the off state. The NCR-FWD 708 will remain in the off state for x-y time units to complete the x (e.g., 4) time units period. The NCR-FWD 708 will repeat this x time units period process, i.e., remains in the on state for the first y time units and transitions to the off state and remains in the off state for the next x-y time units, until the NCR-MT 707 deactivates the NCR-FWD 708 according to another received control message containing an OFF indication from the base station 702.

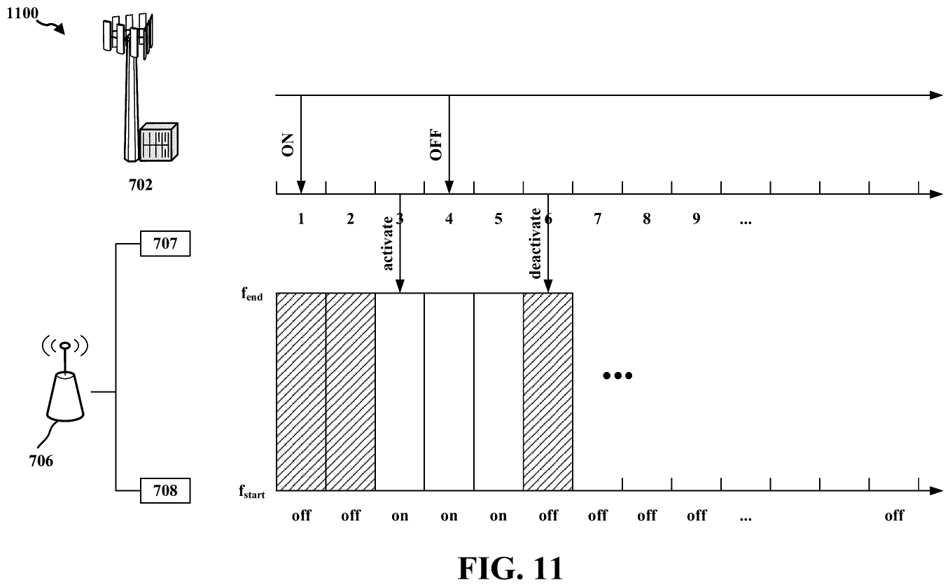

FIG. 11 is a diagram 1100 illustrating a first frequency domain resource configuration included in a control message. The NCR-FWD 708 is capable of receiving and forwarding the DL/UL RF signals in a frequency range [fₛₜₐᵣₜ, f_{end}]. When the NCR-MT 707 receives an ON indication from the base station 702, the NCR-MT 707 will activate the NCR-FWD 708 and the entire frequency range [fₛₜₐᵣₜ, f_{end}] of the NCR-FWD 708 transitions from the OFF state to the ON state. This allows the NCR-FWD 708 to forward signals over its full frequency range.

When the NCR-MT 707 receives an OFF indication from the base station 702, the NCR-MT 707 will deactivate the NCR-FWD 708 and the entire frequency range [fₛₜₐᵣₜ, f_{end}] of the NCR-FWD 708 transitions from the ON state to the OFF state. This disables signal forwarding over the entire frequency range of the NCR-FWD 708.

In this manner, the ON/OFF indicators can control the NCR-FWD 708 to enable or disable forwarding over its full supported frequency range [fₛₜₐᵣₜ, f_{end}].

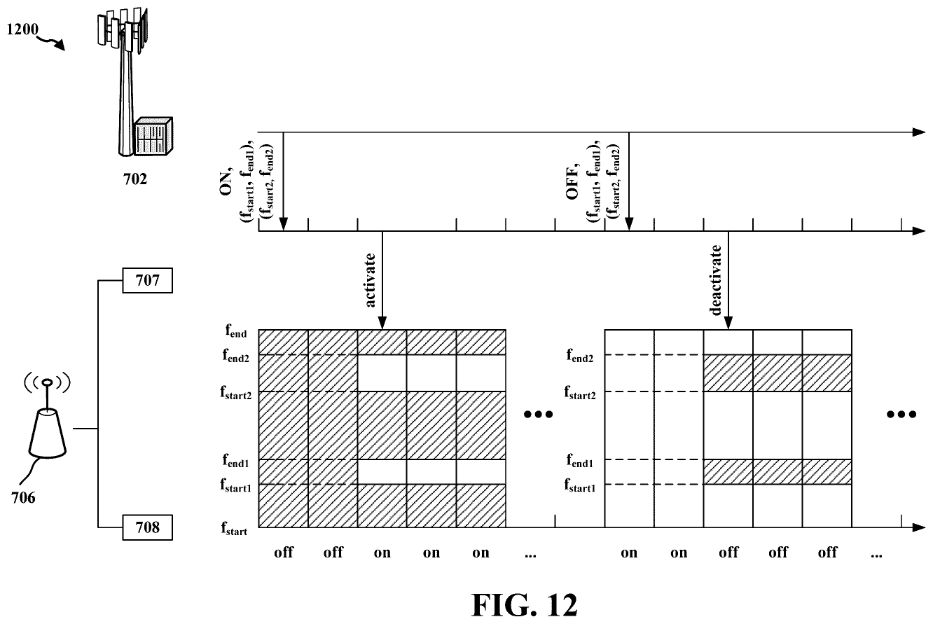

FIG. 12 is a diagram 1200 illustrating a second frequency domain configuration included in a control message. The NCR-FWD 708 is able to receive and forward the DL/UL RF signals in a frequency range [fₛₜₐᵣₜ, f_{end}]. In this example, the base station 702 transmits a control message containing an ON indicator for frequency sub-ranges [fₛₜₐᵣₜ₁, f_{end1}] and [fₛₜₐᵣₜ₂, f_{end2}] to the NCR-MT 707.

When the NCR-MT 707 receives the ON indication from the base station 702, the NCR-MT 707 will activate the frequency sub-ranges [fₛₜₐᵣₜ₁, f_{end1}] and [fₛₜₐᵣₜ₂, f_{end2}] of the NCR-FWD 708. The frequency sub-ranges [fₛₜₐᵣₜ₁, f_{end1}] and [fₛₜₐᵣₜ₂, f_{end2}] of the NCR-FWD 708 transition from the OFF state to the ON state. The remaining frequency range not indicated will remain in the OFF state.

Alternatively, the base station 702 may transmit a control message including an OFF indicator for the frequency sub-ranges [fₛₜₐᵣₜ₁, f_{end1}] and [fₛₜₐᵣₜ₂, f_{end2}] to the NCR-MT 707 when the NCR-FWD is already in the ON state. When the NCR-MT 707 receives the OFF indication from the base station 702, the NCR-MT 707 will deactivate the frequency sub-ranges [fₛₜₐᵣₜ₁, f_{end1}] and [fₛₜₐᵣₜ₂, f_{end2}] of the NCR-FWD 708. The frequency sub-ranges [fₛₜₐᵣₜ₁, f_{end1}] and [fₛₜₐᵣₜ₂, f_{end2}] of the NCR-FWD 708 transition from the ON state to the OFF state. The remaining frequency range will remain in the ON state.

In this manner, the ON/OFF indicators from the base station can selectively control specific frequency sub-ranges of the NCR-FWD 708 to transition between ON and OFF states, while leaving other frequency sub-ranges unchanged. This allows more granular control over the operating frequency bandwidth of the NCR-FWD 708.

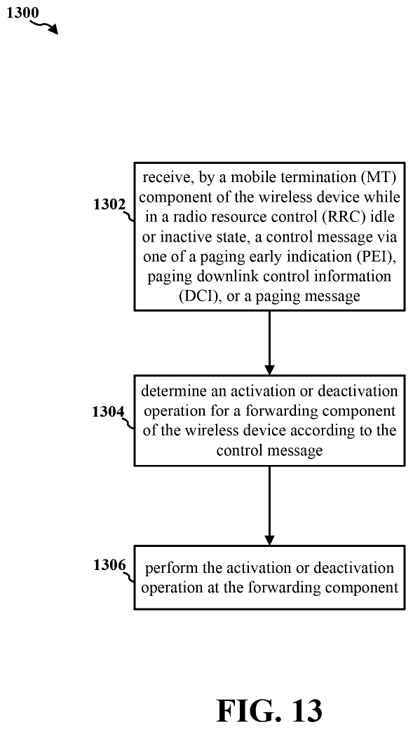

FIG. 13 is a flow chart 1300 of a method (process) for performing activation or deactivation operations. The method may be performed by a wireless device (e.g., the NCR 706, the UE 250). In operation 1302, the wireless device receives, by a mobile termination (MT) component of the wireless device while in a radio resource control (RRC) idle or inactive state, a control message via one of a paging early indication (PEI), paging downlink control information (DCI), or a paging message.

In operation 1304, the wireless device determines an activation or deactivation operation for a forwarding component of the wireless device according to the control message. In operation 1306, the wireless device performs the activation or deactivation operation at the forwarding component.

In certain configuration, the control message may include an activation indication to activate the forwarding component. To activate the forwarding component, the wireless device may activate the forwarding component for a duration indicated in the control message. The activation indication may specify a time location and a frequency location for the forwarding component to operate on after activation. In certain configuration, the control message may include a deactivation indication to deactivate the forwarding component.

The activation or deactivation operation may include at least one of: activating the forwarding component based on the control message; deactivating the forwarding component based on the control message; and deactivating the forwarding component after expiration of an activation duration without receiving an explicit deactivation indication.

When the control message is received via the PEI, the control message may be identified in one or more of: a repurposed paging indication field, a repurposed reference signal transmission availability indication field, a specific field of a DCI format carrying the PEI.

When the control message is received via the paging DCI, the control message may be identified in one or more of: a short message indicator, a short message, a specific field in a DCI format carrying the paging DCI.

When the control message is received via the paging message, the control message may be identified in a specific field in the paging message.

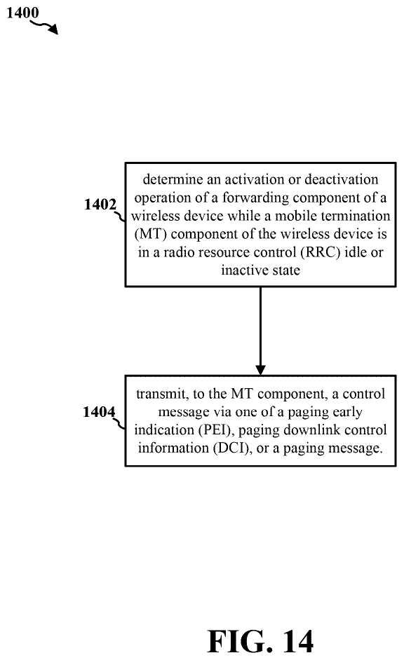

FIG. 14 is a flow chart 1400 of a method (process) for sending activation or deactivation indications. The method may be performed by a base station (e.g., the base station 702, the base station 210). In operation 1402, the base station determines an activation or deactivation operation of a forwarding component of a wireless device while a mobile termination (MT) component of the wireless device is in a radio resource control (RRC) idle or inactive state.

In operation 1404, the base station transmits, to the MT component, a control message via one of a paging early indication (PEI), paging downlink control information (DCI), or a paging message. The control message indicates the activation or deactivation operation determined in operation 1402.

In certain configurations, the control message transmitted in operation 1404 includes an activation indication to activate the forwarding component. The activation indication may specify a time location and frequency location for activating the forwarding component. Activating the forwarding component may comprise activating the forwarding component for a duration indicated in the control message.

In certain configurations, the control message transmitted in operation 1404 comprises a deactivation indication to deactivate the forwarding component. The activation or deactivation operation may include one or more of: activating the forwarding component based on the control message; deactivating the forwarding component based on the control message; and deactivating the forwarding component after expiration of an activation duration without receiving an explicit deactivation indication.

In certain configurations where the control message is transmitted via the PEI in operation 1404, the control message may be identified in one or more of: a repurposed paging indication field, a repurposed reference signal transmission availability indication field, or a specific field of a DCI format carrying the PEI.

In certain configurations where the control message is transmitted via the paging DCI in operation 1404, the control message may be identified in one or more of: a short message indicator, a short message, or a specific field in a DCI format carrying the paging DCI.

In certain configurations where the control message is transmitted via the paging message in operation 1404, the control message may be identified in a specific field in the paging message.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a wireless device, comprising:
receiving, by a mobile termination (MT) component of the wireless device while in a radio resource control (RRC) idle or inactive state, a control message via one of a paging early indication (PEI), paging downlink control information (DCI), or a paging message;
determining an activation or deactivation operation for a forwarding component of the NCR according to the control message; and
performing the activation or deactivation operation at the forwarding component.

2. The method of claim 1, wherein the control message comprises an activation indication to activate the forwarding component.

3. The method of claim 2, wherein activating the forwarding component comprises activating the forwarding component for a duration indicated in the control message.

4. The method of claim 2, wherein the activation indication specifies a time location and a frequency location for the forwarding component to operate on after activation.

5. The method of claim 1, wherein the control message comprises a deactivation indication to deactivate the forwarding component.

6. The method of claim 1, wherein the activation or deactivation operation comprises at least one of:
activating the forwarding component based on the control message;
deactivating the forwarding component based on the control message; and
deactivating the forwarding component after expiration of an activation duration without receiving an explicit deactivation indication.

7. The method of claim 1, wherein the control message is received via the PEI, and wherein the control message is identified in one or more of:
a repurposed paging indication field, a repurposed reference signal transmission availability indication field, a specific field of a DCI format carrying the PEI.

8. The method of claim 1, wherein the control message is received via the paging DCI, and wherein the control message is identified in one or more of:
a short message indicator, a short message, a specific field in a DCI format carrying the paging DCI.

9. The method of claim 1, wherein the control message is received via the paging message, and wherein the control message is identified in a specific field in the paging message.

10. A method of wireless communication of a base station, comprising:
determining an activation or deactivation operation of a forwarding component of a wireless device while a mobile termination (MT) component of the wireless device while is in a radio resource control (RRC) idle or inactive state; and
transmitting, to the MT component, a control message via one of a paging early indication (PEI), paging downlink control information (DCI), or a paging message, wherein the control message indicates the activation or deactivation operation.

11. The method of claim 10, wherein the control message comprises an activation indication to activate the forwarding component.

12. The method of claim 11, wherein the activation indication specifies a time location and frequency location for activating the forwarding component.

13. The method of claim 11, wherein activating the forwarding component comprises activating the forwarding component for a duration indicated in the control message.

14. The method of claim 10, wherein the control message comprises a deactivation indication to deactivate the forwarding component.

15. The method of claim 10, wherein the activation or deactivation operation comprises at least one of:
activating the forwarding component based on the control message;
deactivating the forwarding component based on the control message; and
deactivating the forwarding component after expiration of an activation duration without receiving an explicit deactivation indication.

16. The method of claim 10, wherein the control message is transmitted via the PEI, and wherein the control message is identified in one or more of:
a repurposed paging indication field, a repurposed reference signal transmission availability indication field, a specific field of a DCI format carrying the PEI.

17. The method of claim 10, wherein the control message is transmitted via the paging DCI, and wherein the control message is identified in one or more of:
a short message indicator, a short message, a specific field in a DCI format carrying the paging DCI.

18. The method of claim 10, wherein the control message is transmitted via the paging message, and wherein the control message is identified in a specific field in the paging message.

19. An apparatus for wireless communication, the apparatus being a wireless device, comprising:
a memory; and
at least one processor coupled to the memory and configured to:
receiving, by a mobile termination (MT) component of the wireless device while in a radio resource control (RRC) idle or inactive state, a control message via one of a paging early indication (PEI), paging downlink control information (DCI), or a paging message;
determining an activation or deactivation operation for a forwarding component of the NCR according to the control message; and
performing the activation or deactivation operation at the forwarding component.

20. The apparatus of claim 19, wherein the control message comprises an activation indication to activate the forwarding component.
